(19) United States
(12) Patent Application Publication
(10) Pub. No.: US 2014/0318572 A1
(43) Pub. Date: Oct. 30, 2014

(54) TOOTHPICK

(71) Applicant: Jun Chen, Taipei (TW)

(72) Inventor: Jun Chen, Taipei (TW)

(21) Appl. No.: 13/869,909

(22) Filed: Apr. 24, 2013

(51) Int. Cl. A61C 15/02

(52) U.S. Cl. CPC A61C 15/02
USPC 132/329

(57) ABSTRACT

The Present Invention relates to an Improved Toothpick which comprises of a Handle that can be held by the fingers, and a Cone that can be used for flossing. Said Handle is composed of a Straight Rod, a Tilted Part which is connected to the Straight Rod on one end, and a Bending Part connected to the Tilted Part's other end. When said Straight Rod is in a horizontal state, the Tilted Part is tilted upward, forming a First Included Angle with the extension line of said Straight Rod that is an acute angle. When the Tilted Part is tilted downward, it forms a Second Included Angle with the extension line of said Straight Rod that is an obtuse angle.

### FIELD OF THE INVENTION

The present invention relates to a Toothpick, especially to one Improved Toothpick that can clean one's teeth through different directions.

### BACKGROUND OF THE INVENTION

The origin of the Toothpick could be traced back for a long time, as the Toothpick has been invented since ancient times. Toothpicks have been known in the old times as the “willow branch” due to being used directly from the willow tree by people to get rid of bad breath and improve their sense of taste. As time passes, the Toothpick's shape gradually develops into the column tip today.

The traditional Toothpick has the following problems—As a column rod, its two tips are sharp. When in use, the straight Toothpick is unable to penetrate the slits between the teeth and clean its back, causing tartar to gather in the slits between the teeth, therefore affect its effect of cleaning. Also, the wooden-made Toothpick is easy to be broken and damage the enamel.

To overcome aforementioned disadvantages, a straight plastic Toothpick was invented, yet its handle is not long enough to be picked by fingers and its straight rod is also unable to penetrate and clean the molar teeth's back due to the Toothpick's two tips being too soft to penetrate the slits between the teeth, thus, reduces the effect of flossing considerably.

Although Dental floss was invented afterwards, it is still unable to clean the back of the molar teeth in the mouth, causing food residue and Dental plaque remain on the molar teeth, therefore reducing the effect of using Dental floss considerably.

Reviewing the aforementioned problems, the causes are due to the wrong angle and softness of the Toothpick, the shortness of the handle, the incapability of cleaning the back of the teeth, and could only penetrate the slits between the teeth through one side when using, which are the disadvantages of conventional dental floss and toothpick.

Therefore, to resolve the aforementioned cleaning of the teeth and the slits between the teeth as well as increasing the cleaning effect of the Toothpick has become the main problem this present invention is to improve.

### SUMMARY OF THE INVENTION

To resolve the aforementioned problems of prior art, the present invention provides an Improved Toothpick, which is comprised of:

A Handle (1) that can be held by the fingers, and a Cone (2) that can be used for flossing.

Said Handle (1) is composed of a Straight Rod (11), a Tilted Part (12) which is connected to the Straight Rod (11) on one end, and a Bent Part (13) connected to the Tilting Part's (12) another end.

When said Straight Rod (11) is in horizon, the Tilted Part (12) is tilted upward, forming a First Included Angle (A) with the extension of said Straight Rod (11) that is an acute angle, and the Bent Part (13) is tilted downward, it forms a Second Included Angle (B) with said Tilted Part (12) that is an obtuse angle.

Said Straight Rod (11) is a long rod, while the Tilting Part (12) is a middle rod shorter than the Straight Rod (11), and the Bending Part (13) is a short rod shorter than the Tilting Part (12), with said Cone (2) which is longer than the Bending Part (13). Said Tilting Part (12) and said Bending Part (13) form a bow shape, and form an acute triangle with the horizontal line when said Straight Rod (11) is horizontal.

There is a Straight Hole (14) on the center of bottom of said Bending Part (13), which is through said Bending Part (13).

Said Cone's (2) is made of an eco-friendly material, with one end being a Blunt End (21) that can be positioned by inserting straight into said Straight Hole (14) of the Bending Part (13), while the other end is a Sharp End (23) that is exposed outside said Straight Hole (14).

Said First Included Angle (A) is 18 degrees with the upward and downward variation of 3 degrees.

Said Second Included Angle (B) is 97 degrees with the upward and downward variation of 3 degrees.

Said Handle (1) can be made of either of following: Polypropylene (PP) or polyethylene terephthalate (PET) Plastic.

Said Cone (2) is made of wood, which is selected from arbors with superior Toughness and Hardness.

Said Cone (2) is shown in three parts as the inserted inside the Straight Hole (14), a Straight End (22) and the Sharp End (23) that are exposed outside the Straight Hole (14). Said Straight End (22) is placed between the Blunt End (21) and the Sharp End (23), said Sharp End (23) is longer than the Blunt End (21) and the Straight End (22) is the shortest. Said Blunt End (21) is cone-shaped with a length of 4 mm, the longest diameter is 1.5 mm, and the shortest diameter is 1.3 mm. Said Straight End (22) is an equal-diameter column with a length of 2 mm and a diameter 1.3 mm. Said Sharp End (23) is cone-shaped with a length of 5.5 mm, the longest diameter is 1.3 mm and the shortest diameter is 0.5 mm.

Said the diameter of Straight Rod (11) on the Handle (1) is 5 mm and the ideal length is 7 cm. The length of said Tilted Part (12) is 2.5 cm, with the diameter of the end connecting with the Straight Rod (11) is 5 mm and gradually getting shorter toward the another end, the diameter of the top of said another end is 3.5 mm. The length of said Bending Part (13) is 4 mm, with the diameter of the end connecting with the Tilted Part (12) is 3.5 mm and gradually getting shorter toward another end, the diameter of the top of said another end is 2.8 mm.

Comparing with prior arts, the following advantages of present invention is listed:

First, the present invention can improve the problems the current toothpicks of not being able to penetrate the slits between the teeth and clean the teeth's back. When using, the present invention can cross the teeth in mouth cavity and clean the slits between the teeth from many directions and angles.

Second, the present invention's toothpick structure has a First Included Angle that is set between the Straight Rod and the Tilting Part. This First Included Angle is a special angle of 18 degrees with upward and downward variation of 3 degrees, because this angle can cause the Handle to form a side wedge shape, making it easy to reach the cleaning position when operating by being parallel with the side wall of the teeth.

Third, the present invention's toothpick structure has a Second Included Angle that is set between the Tilted Part and the Bent Part. This Second Included Angle is also a special angle of 97 degrees with upward and downward variation of 3 degrees, because this angle can cause the Cone to be vertical with the slits between the teeth, allowing the present invention to insert the slits between the teeth and clean them.

Fourth, the present invention's Cone is made of Arbor, which has its advantage of being flexible, therefore overcome the problem the bamboo toothpick that could be broken easily and pricking the mouth cavity. Also, the Arbor Cone is less hard than the enamel of the teeth to prevent scratch.

### BRIEF DESCRIPTION OF THE DRAWINGS

FIG. 1: A side view of the present invention.

FIG. 2: A appearance view of the present invention.

FIG. 3: An Exploded view of the present invention.

FIG. 4: A practicing scheme of First Embodiment of the present invention.

FIG. 5: A practicing scheme of Second Embodiment movement of the present invention.

FIG. 6: A practicing scheme of Third Embodiment of the present invention.

FIG. 7: A practicing scheme of Fourth Embodiment of the present invention.

FIG. 8: An enlarged cross-sectional of the present invention's sharp cone, bent part and straight hole.

### DETAILED DESCRIPTION OF PREFERRED EMBODIMENT

The Detailed Description of the Preferred Embodiment of the present invention is as shown in the following drawings:

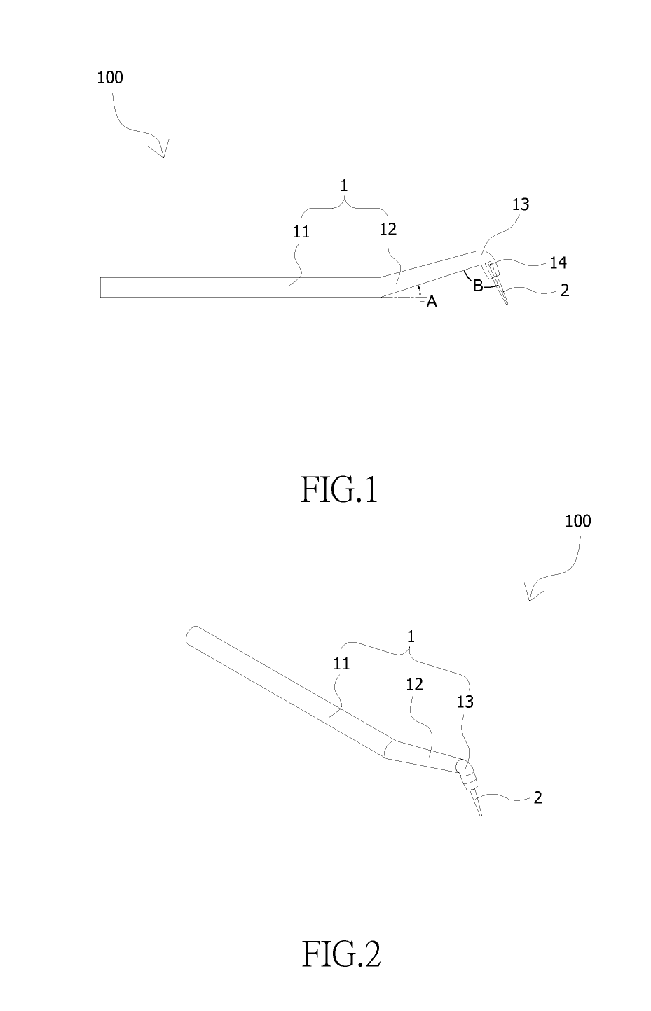

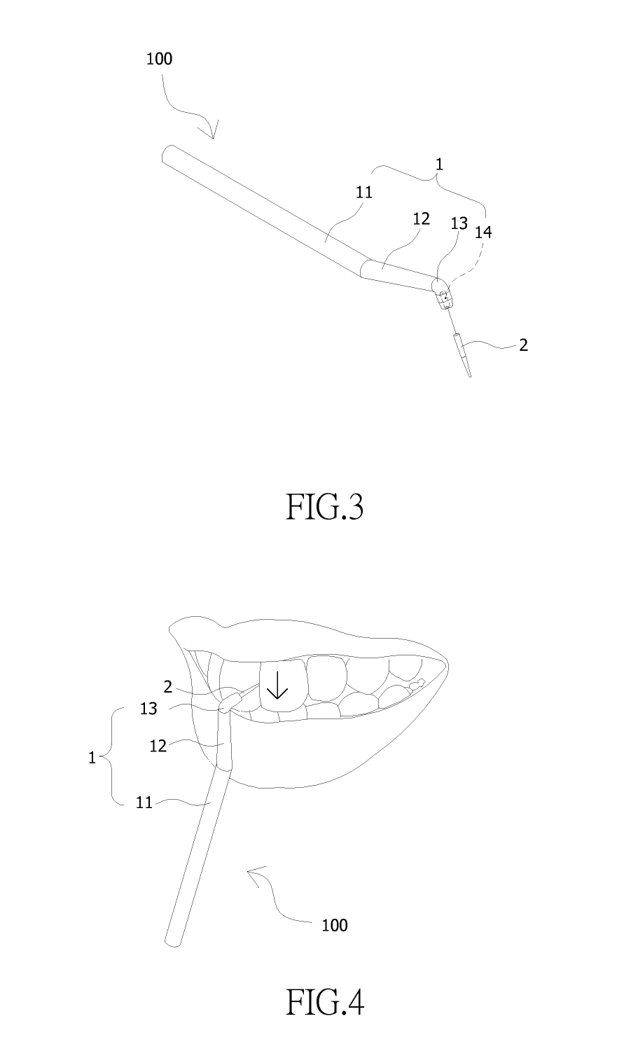

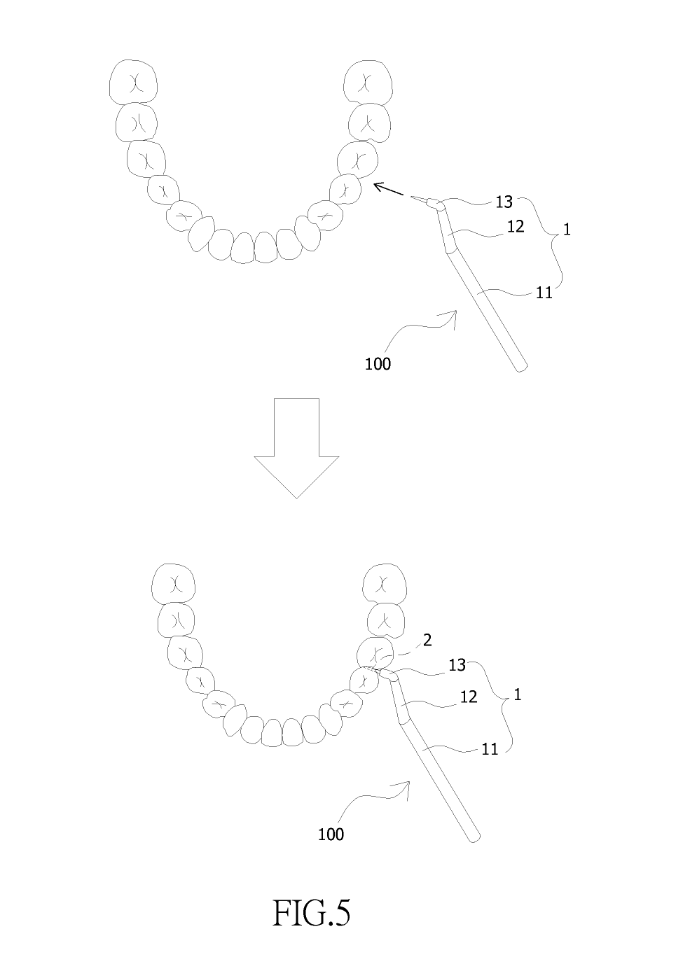

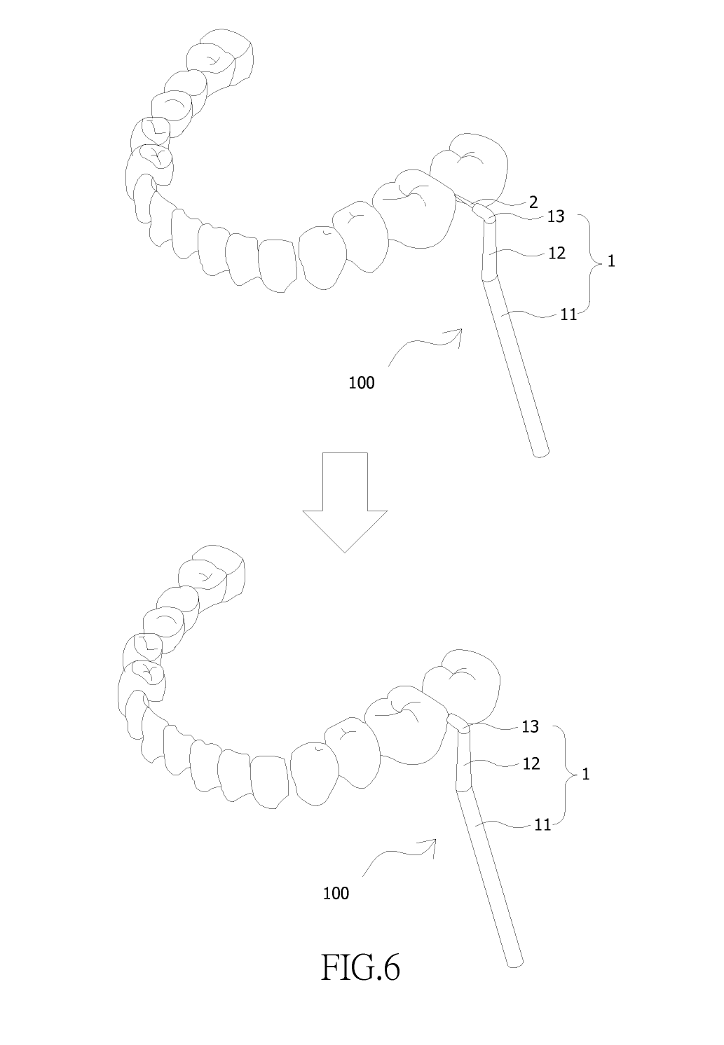

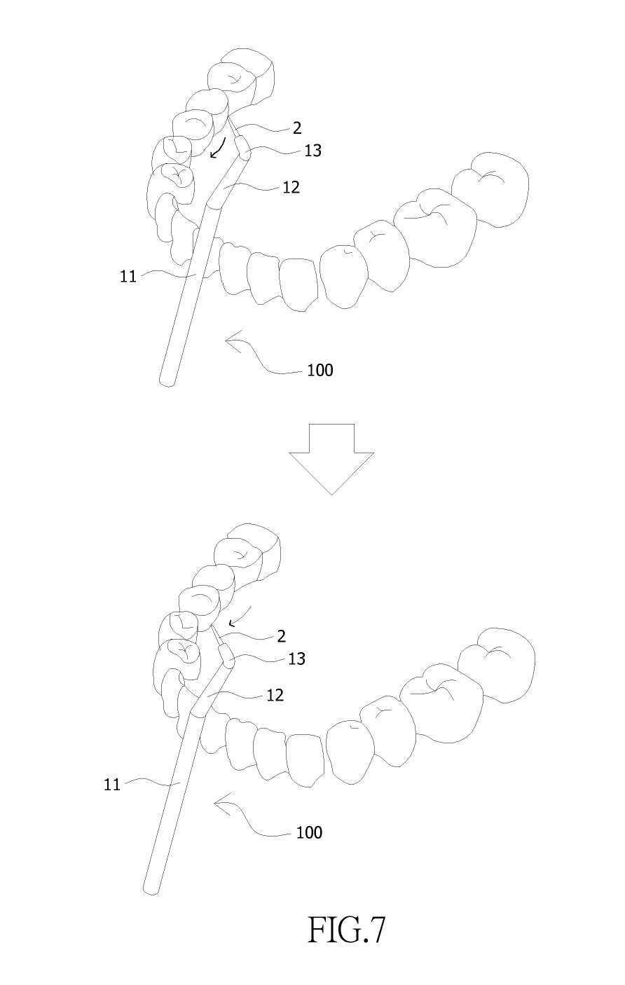

As shown in FIG. 1 & FIG. 2, as an Improved Toothpick, it is characterized as the following: Said Toothpick (100) comprises of:

A Handle (1) that can be held by the fingers, and a Cone (2) that can be used for flossing.

Said Handle (1) is composed of a Straight Rod (11), a Tilted Part (12) which is connected to said Straight Rod (11) on one end, and a Bent Part (13) connected to said Tilted Part's (12) another end.

When said Straight Rod (11) is in a horizontal state, the Tilted Part (12) is tilted upward, forming a First Included Angle (A) with the extension line of said Straight Rod (11) that is an acute angle. When the Tilted Part (12) is tilted downward, it forms a Second Included Angle (B) with the extension line of said Straight Rod (11) that is an obtuse angle.

Said Straight Rod (11) is a long rod, while the Tilted Part (12) is a middle rod shorter than said Straight Rod (11), and the Bent Part (13) is shorter than the Tilting Part (12), with said Cone (2) longer than said Bent Part (13). Said Tilted Part (12) and Bent Part (13) form a bow shape and the bow becomes an acute triangle with horizon.

There is a Straight Hole (14) on the center bottom of said Bent Part (13).

Said Cone (2) is made of different material from the Handle (1), which is eco-friendly, with one end is a Blunt End (21) that can be positioned by inserting straight into the Straight Hole (14) of the Bent Part (13), and another end is a Sharp End (23) that is exposed outside said Straight Hole (14).

Said First Included Angle (A) has an angle of 18 degrees with upward and downward variation of 3 degrees.

Said Toothpick's (100) structure has a special angle, the First Included Angle (A). Its angle of 18 degrees with upward and downward variation of 3 degrees is the best angle after many experiments, because this angle can cause the Handle (1) to form a side wedge shape, making it easy to reach the cleaning position when said Handle (1) become parallel with the wall of the teeth.

Said Second Included Angle (B) has an angle of 97 degrees with upward and downward variations of 3 degrees.

Said Handle (1) can be the either following: a Polypropylene (PP) or Polyethylene terephthalate (PET) Plastic Handle, thus reduce weight and make it more easy and convenient to carry.

Said Cone (2) is made of wood, with its advantage of being flexible and not having the problem the bamboo toothpick has for breaking easily and pricking the mouth cavity.

Also, said Cone (2) can be made of other eco-friendly materials, but the best material is selected from the Arbor with toughness and hardness, besides, the Arbor Cone (2) is less hard than the teeth and cannot scratch the enamel easily.

Also, after the Cone's (2) Blunt End (21) is inserted into said Handle's (1) Straight Hole (14), it is immediately fixed in position. Therefore, when in use, the Cone (2) would not detach nor fall from the Handle (1), and be disposable after use, thus, fulfilling the Health & Safety requirements.

Please refer to FIGS. 3˜7, as they are the schemes for the present invention's Toothpick (100) flossing the slits between the teeth through different angles, different depths, and different directions. The present invention's Toothpick's (100) Straight Rod (11) has enough length for the fingers to hold it and insert in the mouth cavity, making it easy on cleaning the deeper space of mouth cavity. The bow-shaped Tilted Part (12) and Bent Part (13) can avoid both friction and colliding with the teeth, making it become easier to clean all the slits between the teeth through either the front, back, up, down, left or right of the teeth. The Cone (2) can also enter the slits between the teeth easily and floss away the food stuck in them. It has appropriate hardness and toughness without harming the enamel. Also, the present invention is capable of scraping away the early forms of dental calculus that are usually formed after 45-60 days from dental cleaning. Concluding all that is mentioned above, the present invention is capable of preventing any periodontal disease, making it a useful tool on dental care.

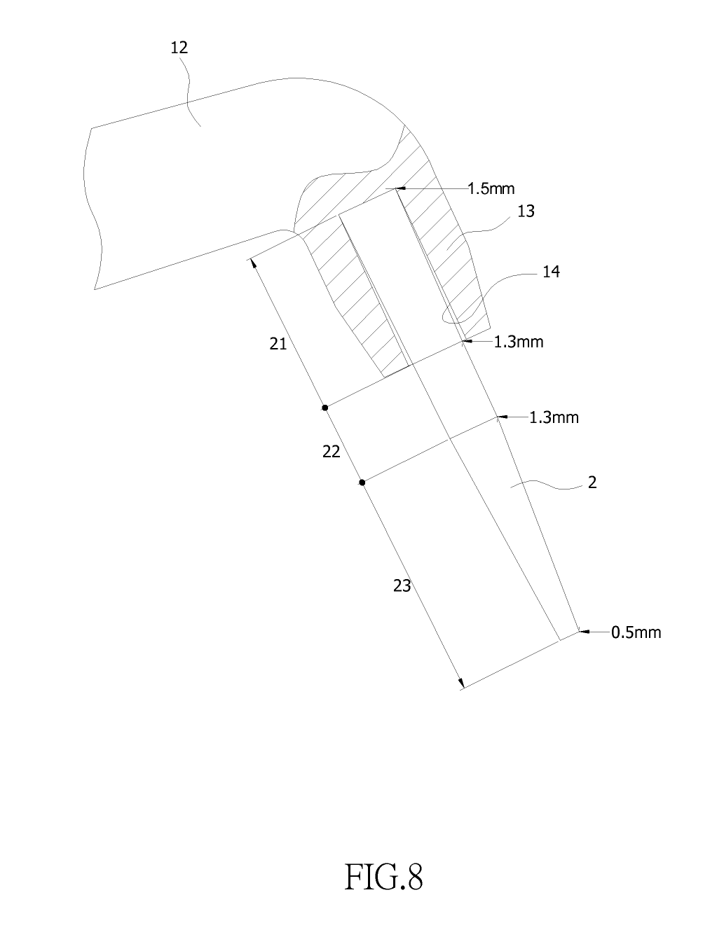

Said Cone's (2) shape, as shown in FIG. 8, is the best proportional scale after many trials and long experiments. It is shown in three parts as the Blunt End (21) inserted inside the Straight Hole (14), a Straight End (22) and Sharp End (23) are exposed outside said Straight Hole (14). Said Straight End (22) is placed between the Blunt End (21) and the Sharp End (23), said Sharp End (23) is longer than the Blunt End (21) and the Straight End (22) is the shortest. Said Blunt End (21) is cone-shaped with a length of 4 mm, the largest diameter is 1.5 mm and the shortest diameter is 1.3 mm. Said Straight End (22) is an equal-diameter column with a length of 2 mm and a diameter 1.3 mm. Said Sharp End (23) is cone-shaped with a length of 5.5 mm, the longest diameter is 1.3 mm and the shortest diameter is 0.5 mm. Said Cone (2), as shown in the best proportional scale, is not only moderate in hardness and toughness, but also long enough for its own positioning and use in flossing.

Also, the ideal length of said Handle's (1) Straight Rod (11) is 7 cm, and diameter is 5 mm. Said Tilted Part (12) has a length of 2.5 cm, with the diameter of one end connects with said Straight Rod (11) is 5 mm, and gradually getting shorter toward another end, the diameter of the tip of another end is 3.5 mm. The length of said Bent Part (13) is 4 mm, the diameter of one end connects with the Tilted Part (12) is 3.5 mm and gradually getting shorter toward another end, the diameter of the tip of another end is 2.8 mm.

What is claimed is:

1. An Improved Toothpick. Said Toothpick (100) comprises of:
A Handle (1);
A Cone (2);
Said Handle (1) is composed of a Straight Rod (11), a Tilted Part (12) which is connected to said Straight Rod (11) on one end, and a Bent Part (13) connects to the Tilted Part's (12) another end;
When said Straight Rod (11) is in a horizontal state, said Tilted Part (12) is tilted upward, forming a First Included Angle (A) with the extension line of said Straight Rod (11) that is an acute angle; when the Tilted Part (12) is tilted downward, it forms a Second Included Angle (B) with the extension line of said Straight Rod (11) that is an obtuse angle;
Said Straight Rod (11) is a longest rod, while the Tilted Part (12) is a middle rod shorter than said Straight Rod (11), and the Bent Part (13) is shorter than said Tilted Part (12), said Cone (2) is longer than said Bent Part (13), said Tilted Part (12) and said Bent Part (13) form a bow shape which becomes an acute triangle with the horizontal line;
There is a Straight Hole (14) on the center bottom of said Bent Part (13); Said Cone's (2) material is eco-friendly, one end is a Blunt End (21) that can be positioned by inserting straight into the Hole (14) of said Bent Part (13), and another end is a Sharp End (23) that is exposed outside said Straight Hole (14).

2. The Improved Toothpick described in claim 1, wherein said First Included Angle (A) has an angle of 18 degrees with upward and downward variation of 3 degrees.

3. The Improved Toothpick described in claim 1, wherein said Second Included Angle (B) has an angle of 97 degrees with upward and downward variation of 3 degrees.

4. The Improved Toothpick, as described in claim 1, wherein said Handle (1) is made of one of following:
Polypropylene (PP) or Polyethylene terephthalate (PET).

5. The Improved Toothpick, as described in claim 1, wherein said Cone (2) is made of arbor.

6. The Improved Toothpick described in claim 1, wherein said Cone (2) is shown in three parts as the Blunt End (21) inserted inside the Straight Hole (14), a Straight End (22) that is exposed outside the Straight Hole (14), and the Sharp End (23);
Said Straight End (22) is placed between the Blunt End (21) and the Sharp End (23), said Sharp End (23) is longer than the Blunt End (21), the Straight End (22) is shortest, said Blunt End (21) is cone-shaped with a length of 4 mm, the longest diameter is 1.5 mm, and the shortest diameter is 1.3 mm, said Straight End (22) is an equal-diameter column with a length of 2 mm and a diameter of 1.3 mm, said Sharp End (23) is cone-shaped with a length of 5.5 mm, the longest is diameter of 1.3 mm and the shortest diameter is 0.5 mm.

7. The Improved Toothpick described in claim 1, wherein the ideal length of said Handle's (1) Straight Rod (11) is 7 cm, and the diameter is 5 mm, said Tilted Part (12) has a length of 2.5 cm, with the diameter of the end connects with said Straight Rod (11) is 5 mm and gradually getting shorter toward another end, the diameter of the tip of another end of said Tilted Part (12) is 3.5 mm, said Bent Part (13) has a length of 0.4 cm, with the diameter of the end connects with the Tilted Part (12) is 3.5 mm and gradually getting shorter toward another end, the diameter of the tip of another end of said Bent Part (13) is 2.8 mm.
